(19) United States
(12) Patent Application Publication
(10) Pub. No.: US 2008/0293006 A1
(43) Pub. Date: Nov. 27, 2008

(54) Method and Device for Oral Irrigation

(76) Inventor: Mark C. McCauley, Delray Beach, FL (US)

Correspondence Address: MAYBACK & HOFFMAN, P.A., 5722 S. Flamingo Road, #232, Fort Lauderdale, FL, 33330, US

(21) Appl. No.: 11/752,694

(22) Filed: May 23, 2007

(51) Int. Cl. A61C 17/032

(52) U.S. Cl. 433/80

(57) ABSTRACT

A portable oral irrigation device includes a generally tubular-shaped liquid-holding reservoir suitable for being held in a hand, a nozzle coupled to the reservoir the nozzle having a generally arcuate conical shape along a length of the nozzle and being tapered toward an outlet thereof and a pressurizer coupled to the reservoir, the pressurizer operable for creating a positive pressure inside the reservoir.

### FIELD OF THE INVENTION

The present invention relates generally to oral hygiene, and more particularly relates to a portable device capable of delivering a high-pressure stream of water to a user's mouth for the purpose of irrigating spaces that may trap foreign particles.

### BACKGROUND OF THE INVENTION

It is well known in the oral-health field that food, candy, or other similar substances left on a person's teeth for an extended period of time can result in deleterious effects. Examples of these effects are gum disease, halitosis, and tooth decay. Gum diseases include periodontitis, or pyorrhea, which is a disease involving inflammation of the gingiva. Often persisting unnoticed for many years in a patient such conditions can result in loss of clinical periodontal attachment between the teeth and the surrounding alveolar bone. Tooth decay is an infectious disease that damages the structures of teeth. These diseases can lead to pain, tooth loss, infection, and, in severe cases, death.

To combat these potentially damaging conditions, people have been inventing and using devices to clean their teeth for hundreds of years. By far the most famous and widely used of these devices is the toothbrush. However, a toothbrush is not able to reach and, therefore, is unable to remove, food particles that are caught in the tight narrow space between two teeth.

One way to remove food particles from between two teeth is by using dental floss, which is usually a either a bundle of thin nylon filaments or a plastic (teflon or polyethylene) ribbon. Dental floss is held between the fingers, inserted between the teeth, and scraped along the sides of the teeth, especially close to the gums. However, floss can be difficult to grasp due to the tension required to force the floss between certain teeth. Because one hand must reach inside the mouth to hold one end of the floss, a loss in friction results from the fingers and floss becoming wet from saliva. Flossing also commonly results in pain and/or bleeding of the gums. It is also difficult to run the floss under certain dental work, such as bridges.

An alternative to flossing is the irrigation of the spaces between teeth with relatively high-pressure water. The high-pressure water forces all particles out from between the teeth and from under bridge work. This method of particle removal is advantageous in that it does not damage or irritate the gums, yet, it still effectively forces out the trapped particles. A water nozzle is also easier to hold and use than a thin piece of dental floss, which requires two hands.

Unfortunately, all known oral irrigating devices are large. Their size is mainly due to the presence of a large water tank and a motor for moving the water from the tank through the nozzle at a high pressure. There is also a need for an external power source, e.g. A/C plug in, to run the motor. As a result, users generally do not take their oral water irrigation devices with them on trips. This results in periods of time where the user's teeth are left unclean, thereby allowing damage to occur.

Therefore, a need exists to overcome the problems with the prior art as discussed above.

### SUMMARY OF THE INVENTION

[THIS SECTION TO BE COMPLETED AFTER INVENTOR APPROVAL OF THE CLAIMS SECTION]

Briefly, in accordance with the present invention, disclosed is . . .

In accordance with another feature, an embodiment of the present invention includes . . .

In accordance with a further feature of the present invention, . . .

In accordance with a further feature of the present invention, . . .

In accordance with the present invention, a method for . . .

In accordance with another feature, an embodiment of the present invention also includes.

In accordance with yet another feature, an embodiment of the present invention includes.

In accordance with a further feature of the present invention, . . .

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a side elevational view of a portable irrigation device in accordance with the present invention;

FIG. 2 is a side hidden view of a portable irrigation device of FIG. 1 with the internal mechanisms shown;

FIG. 3 is a bottom plan view of a portable irrigation device in accordance with the present invention;

FIG. 4 is a fragmentary side elevational view of the pressurizer device from the device of FIG. 1 being withdrawn in accordance with the present invention;

FIG. 5 is a fragmentary side elevational view of the pressurizer device from the device of FIG. 1 being inserted in accordance with the present invention;

FIG. 6 is a front elevational view of the portable irrigation device of FIG. 1;

FIG. 7 is a side hidden view of an alternative embodiment of a portable irrigation device in accordance with the present invention with a nozzle acting as the actuator for the pressurizer;

FIG. 8 is a fragmentary side elevational view of a trigger and valve in accordance with the present invention;

FIG. 9 is process flow diagram of a use of a portable irrigation device in accordance with the present invention; and

FIG. 10 is a side elevational view of the nozzle from the device of FIG. 1 in accordance with the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The present invention provides a novel and efficient portable oral irrigation device that can be used virtually anywhere for at least the purpose of proper maintenance of teeth and gums. Embodiments of the invention provide a precise liquid output that delivers liquid accurately to a target area. In addition, embodiments of the invention provide a portable oral irrigation device that does not required an external power source, but instead, supplies its own mechanism for causing liquid to be propelled from the device.

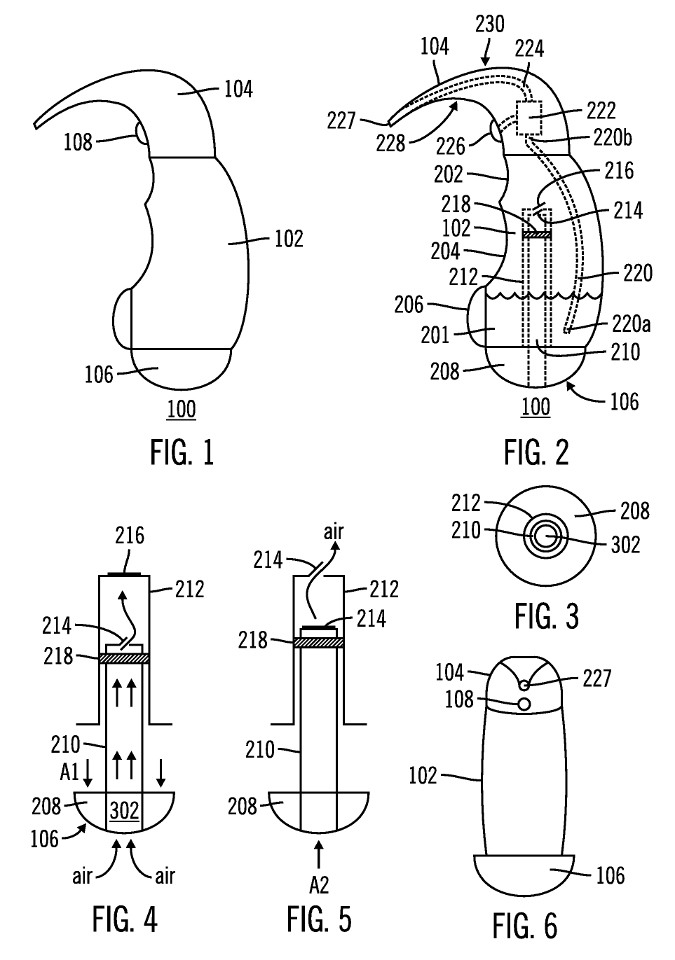

Referring now to FIG. 1, one embodiment of the present invention is shown in a side view. FIG. 1 shows several advantageous features of the present invention, but, as will be described below, the invention can be provided in several shapes, sizes, combinations of features and components, and varying numbers and functions of the components. The first example of an oral irrigation device 100, as shown in FIG. 1, includes the four main components of a reservoir 102, a nozzle 104, a pressurizer 106, and a trigger 108. Stated generally, the reservoir 102 holds an amount of liquid (not shown in this view). The pressurizer 106 provides and applies propellant force (pressure) to the liquid so that when the trigger 108 is used to open a path from the pressurized reservoir 102 to the nozzle 104, the liquid is emitted from the liquid ejecting portion of the nozzle 104 in a focused stream that is able to be directed to areas as narrow as the space between two teeth. The inventive oral irrigation device 100 is advantageous, as it is portable and sized to fit within a user's hand. The oral irrigation device 100 can be taken on trips, to work, used at home, or anywhere else, so that a user can blast particles from between his/her teeth with the high-pressure liquid emitted from the nozzle 104. Any liquid can be placed inside the reservoir 102, which can be easily refilled once empty.

FIG. 2 shows the oral irrigation device 100 in slightly more detail than was shown in FIG. 1. In FIG. 2, the pressurizer 106 is represented partially by solid lines (as was shown in FIG. 1) and partially by hidden lines to show the portions of the pressurizer 106 that are located within the reservoir 102. The reservoir 102 can be any container that is capable of holding a liquid 201. In the particular embodiment shown in FIG. 2, the reservoir 102 is provided with indentions 202 and 204 and a finger holder 206, thus providing an ergonomic design that is able to fit comfortably and securely in a user's hand. Of course, the reservoir 102 is not limited to any particular shape.

Directly below the reservoir 102 in the embodiment of FIGS. 1 and 2 is an actuator 208 of the pressurizer 106. The actuator 208 is graspable by a user so that the user can slide the actuator 208 alternately away from and toward the reservoir 102 to cause the pressurizer 106 to pressurize the reservoir 102. It should be noted that, although the pressurizer 106 will be described herein as being slidable away from and toward the reservoir, any movement can be used and there are many other mechanisms for applying pressure to the interior of the reservoir that can also be used within the spirit and scope of the invention. Therefore, the invention is not limited to any particular method or means of applying pressure to the reservoir.

Continuing with the exemplary embodiment shown in FIG. 2, the pressurizer actuator 208 is fixedly coupled to a slider 210 that slides within a tube 212 that is fixed with reference to the reservoir 102. Therefore, when the actuator 208 moves, the slider 210 also moves with reference to the reservoir 102 and the tube 212. The slider 210 is, in this particular example, a tubular structure that allows air to pass from outside the actuator 208 to a void within the slider's center. FIG. 3 shows a bottom view of the actuator 208 where the center void 302 of the slider 208 can be seen.

Referring briefly back to FIG. 2, the slider 210 is provided with a valve 214. As can also be seen, the tube 212 is also provided with a valve 216. The valves 214 and 216 allow air to enter the reservoir 102 when the actuator 208 is moved relative to the tube 212, and attached reservoir 102. Specifically, the valve 214 in the slider 210, when opened, places the tube 212 in fluid communication with the air outside of and surrounding the device 100. The view shown in FIG. 2 is of the valve 214 open. The valve 214 will remain open when the actuator 208 is pulled away from, or out of the tube section 212. Correspondingly, the valve 216 of the tube section 212 remains closed when the slider 210 is pulled away from, or out of the tube section 212. In other words, when the valve 214 is open, the valve 216 is closed.

The moving parts of the pressurizer 106 are shown in FIG. 4. The closed tube section 212 creates a vacuum when the slider 210 is pulled away from (indicated by arrows A1), or out of the tube section 212. The vacuum forces air to flow from outside of the pressurizer 106, through the slider center 302, through the slider valve 214, and into the tube 212.

As is shown in FIG. 5, when the actuator 208, and corresponding slider 210 are pushed back (indicated by arrow A2) into the tube section 212, the valve 214 of the slider 210 closes. In one exemplary embodiment, the slider 210 and tube 212 have a tolerance between an outside dimension of the slider 210 and an inside diameter of the tube 212 that prevents air from escaping from within the tube 212. In an exemplary embodiment, shown in FIGS. 2, 4, and 5, a rubber seal 218 is provided on the slider 210 that creates a substantially fluid-tight seal between slider 210 and the tube 212. As is shown in FIG. 5, when the slider 210 is pushed back into the tube section 212 (indicated by arrow A2), the valve 216 of the tube section 212 opens. The slider 210 with the closed valve 214, when being inserted within the tube 212, is analogous to a syringe. The slider 210 places a positive pressure within the tube 212, thereby causing the air that entered the tube 212 when the slider 210 was earlier removed to be forced into the reservoir area 102 through the valve 216. The result of moving the slider is that each time the slider 210 is pressed back into the tube 212, the pressure inside the reservoir 102 increases.

Referring now back to FIG. 2, the pressure inside the reservoir 102 presses down on the liquid 201 within the reservoir 102. A liquid intake tube 220 has a first end 220a that extends down into the liquid 201 and a second end 220b that attaches to a valve 222. In one embodiment of the present invention, the first end 220a of the intake tube 220 is provided with a weight and the intake tube 220 is made of a flexible material. The weighted end of the flexible intake tube 220 allows the tube 220 to be pulled by gravity and to follow and be immersed in the liquid 201 no matter what the orientation of the reservoir 102 is. In another exemplary embodiment, the first end 220a is fixed to the bottom of the reservoir 102.

The valve 222 has at least two positions; open and closed. When placed into the open position, the valve 222 couples the liquid 201, through the liquid intake tube 220, to a liquid output pathway 224, which provides a path out of the nozzle 104 of the device 100. Once the valve 222 couples the liquid intake tube 220 to the liquid output pathway 224, the positive pressure inside the reservoir 102 forces the liquid through the liquid intake tube 220 and the liquid output pathway 224 and out of the nozzle 104 at a pressure corresponding to the internal pressure within the reservoir 102.

In one embodiment of the present invention, a trigger switch 226 causes the valve 222 to change from the closed state to the open state. The switch 226 is, in one exemplary embodiment located on the nozzle 104, as shown in FIG. 2, at a location that is easily reached by a user's finger when the user is holding the device 100. Of course, the trigger switch 226 and the valve 222 can be located anywhere upon the device 100.

The nozzle 104, as shown in FIGS. 1 and 2, has a generally arcuate, or curved shape that runs along the length of the nozzle 104 substantially from the reservoir 102 to the outlet 227. More specifically, the nozzle 104 has a concaved underside surface 228 and a convex upper surface 230 so that both the upper surface 230 and the underside surface 228 follow approximately parallel, but slightly converging, arcs. In the embodiment shown in FIGS. 1 and 2 the nozzle 104 is tapered toward the outlet 227, although the invention is not so limited and can be the shape of a simple curved constant diameter tube, as shown in FIG. 8.

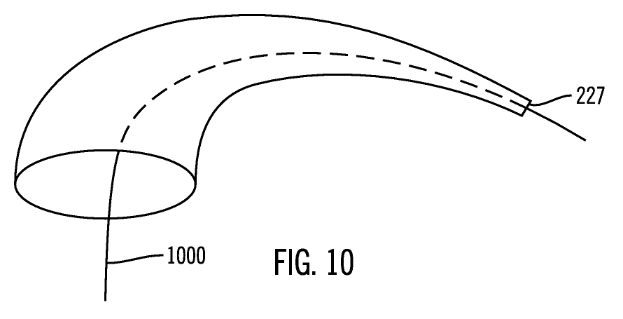

In an exemplary embodiment of the present invention, as shown in FIG. 10, the nozzle 104 is an arcuate truncated conical shape. In this embodiment, the nozzle 104 has a curved, or arcuate, imaginary centerline 1000, of which the conical shape generally follows. The conical shape does not have to be circular, but can also be elliptical, ovular, or any other geometry. The truncation is at the liquid outlet opening 227.

The curved and tapered conical shape is particularly well suited for reaching small areas within a user's mouth. It can easily extend over a users lips and teeth to reach the spaces between teeth. FIG. 6 shows a front view of the portable irrigation device 100. As can be seen in the view of FIG. 6, the output 227 of the nozzle 104 has a generally round shape, although the invention is not so limited. If desired, the nozzle 104 can have protuberances for resting against a user's lips to aid in the fluid-tight seal between the user's mouth and the nozzle 104.

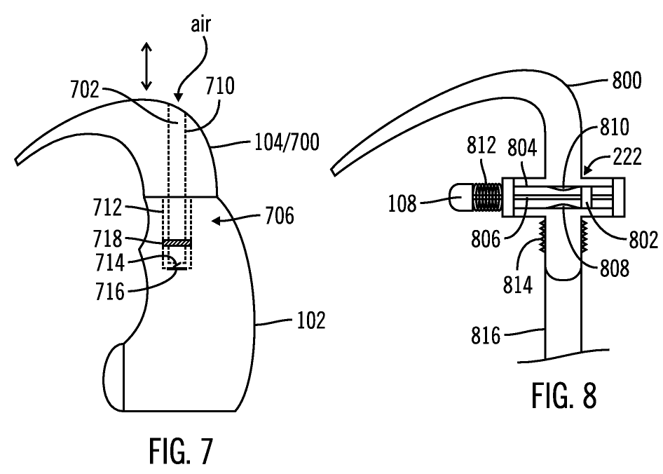

FIG. 7 shows another exemplary embodiment of the present invention. In this embodiment, the nozzle 104 and the actuator 700 of the pressurizer 706 are one and the same. The nozzle 104 moves relative to the reservoir 102 and performs the same function as does the actuator 208 of FIG. 2. That is, a closed tube section 712 creates a vacuum when the slider 710 is pulled away from or out of the tube section 712. A vacuum created by the slider's movement forces air to flow from outside of the pressurizer 706, through the slider center 702, through the slider valve 714, and into the tube 712.

When the actuator 104/700, and corresponding slider 710 are pushed back into the tube section 712, the valve 714 of the slider 710 closes. In an exemplary embodiment, the slider 710 and tube 712 have a tolerance between an outside dimension of the slider 710 and an inside diameter of the tube 712 that prevents air from escaping from within the tube 712. A seal 718 made of rubber, for example, can be provided on the slider 710 to create a substantially liquid-tight seal between slider 710 and the tube 712. When the slider 710 is pushed back into the tube section 712, the valve 716 of the tube section 712 opens. The slider 710 places a positive pressure within the tube 712, thereby causing the air that entered the tube 712 when the slider 710 was earlier removed to be forced into the reservoir area 102 through the valve 716. The result of moving the slider is that each time the slider 710 is pressed back into the tube 712, the pressure inside the reservoir 102 increases.

FIG. 8 shows a detailed view of one exemplary embodiment of the trigger 108 and valve 222. In this particular embodiment, the valve 222 has a stopper 802 located inside the body 804 of the valve 222. The stopper 802 is fixedly attached to a shaft 806 that runs from within the body 804 out of the nozzle 800 and is attached to the trigger 108. A set of threads 814 provides a means for attaching the nozzle 800 to a reservoir (not shown in this figure). In addition, a liquid intake tube 816 provides measures for transporting liquid from a lower section of the reservoir (not shown) up to the nozzle 800 and valve 222. In this configuration, a movement of the trigger 108 results in a corresponding movement of the stopper 802. In a first position of the trigger 108, the connected stopper 802 is located between and blocks a path between an entrance 808 and an exit 810 of the body 804. In this position, no liquid can pass through the body 804. In a second position, where the trigger 108 is depressed, the connected stopper 802 is moved out from between the entrance 808 and exit 810 of the body 804. In this position of the trigger 108 and stopper 802, there is nothing to prevent the liquid from passing from the reservoir 102, through the valve body 804, to the nozzle 800. A spring 812 located between the nozzle body 800 and the trigger 108 acts upon the trigger 108 to force the trigger to return to the first position, where the stopper 802 is located between the entrance 808 and exit 810.

In one embodiment, at least a portion of the reservoir 102 is made of a flexible compressible material so that the reservoir itself can be compressed by squeezing the flexible material. The flexible material allows the reservoir to compress and then return to its original shape. The material has an air inlet that allows air to enter the reservoir as it expands back to its original shape and closes as the reservoir 102 is again compressed. Again, the present invention is not limited to any particular material or combination of materials.

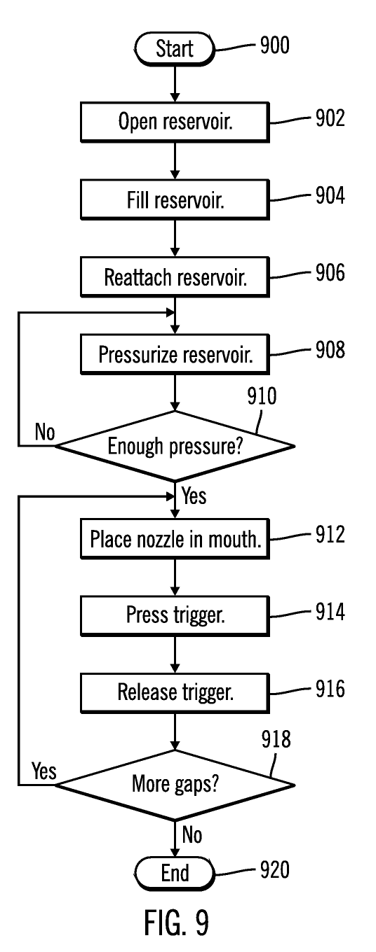

FIG. 9 shows a process flow for irrigating a user's mouth in accordance with embodiments of the present invention. The process begins at step 900 and moves directly to step 902. In step 902, the nozzle 104 is separated from the reservoir 102. The nozzle 104 and reservoir 102 can be coupled by any known measures, including threaded surfaces, snap locks, interlocking mechanism, or any other. In step 904, liquid is placed inside the reservoir 102. Then, in step 906, the nozzle 104 and reservoir 102 are re-attached to one another. In step 908, the actuator 208 of the pressurizer 106 is manipulated to place a positive pressure inside the reservoir 102. In step 910, a check is made to determine whether or not sufficient pressure has been placed inside the reservoir 102. If sufficient pressure has not been placed therein, the flow moves back to step 908 and additional pressure is placed inside the reservoir. If sufficient pressure has been placed inside the reservoir, the flow moves on to step 912, where a user places the outlet 227 of the nozzle 104 to his/her mouth, for example, pointed at a space between two teeth. In step 914, the trigger 108 is depressed and liquid within the reservoir is emitted from the nozzle exit 227 under pressure. In step 916, the user releases the trigger 108 and the flow of liquid stops. In step 918, a check is made to see if any additional spaces within the user's mouth require irrigation or if the same space requires additional irrigation. If the answer to step 918 is yes, the flow moves back up to step 912. If the answer to step 918 is no, the process moves to step 920 and ends.

A portable irrigation device has been disclosed that allows a user to easily carry and use regardless of time and place. The inventive device can work with virtually any liquid and without the need for electricity. Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

The terms “a” or “an”, as used herein, are defined as one, or more than one. The term “plurality”, as used herein, is defined as two, or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

What is claimed is:

1. A portable oral irrigation device comprising:
a liquid-holding reservoir;
an arcuate-shaped nozzle having:
an input in fluid communication with the reservoir; and
an outlet in fluid communication with the input and having an interior shape to project a focused stream of liquid therefrom; and
a pressurizer coupled to the reservoir, the pressurizer operable for creating a positive pressure inside the reservoir.

2. The portable oral irrigation device according to claim 1, wherein:
the arcuate-shaped nozzle follows a curved centerline along a length of the nozzle and is tapered toward an outlet thereof.

3. The portable oral irrigation device according to claim 1, wherein:
the nozzle has a shape of an arcuate truncated cone with a centerline curved along a length of the nozzle.

4. The portable oral irrigation device according to claim 1, wherein:
at least a portion of the nozzle is tubular.

5. The portable oral irrigation device according to claim 1, further comprising:
a liquid emitter valve selectively opening and closing a fluid path between the reservoir and the nozzle outlet.

6. The portable oral irrigation device according to claim 1, wherein:
the pressurizer is integrated into the reservoir.

7. The portable oral irrigation device according to claim 1, wherein:
the pressurizer includes a movable portion that collects air therein when moved in a first direction and inserts the collected air into the reservoir when moved in a second direction.

8. The portable oral irrigation device according to claim 7, wherein:
the first direction is opposite the second direction.

9. The portable oral irrigation device according to claim 1, wherein:
the nozzle is movably connected to the reservoir to extend away from and be returned towards the reservoir and, when so moved, operates the pressurizer to create the positive pressure inside the reservoir.

10. The portable oral irrigation device according to claim 1, wherein:
the reservoir has an upper portion and a bottom portion movably connected to the upper portion to extend away from and be returned towards the reservoir and, when so moved, operates the pressurizer to create the positive pressure inside the upper reservoir.

11. The portable oral irrigation device according to claim 1, wherein:
the pressurizer includes a compressible member inserting air into the reservoir upon compression thereof.

12. The portable oral irrigation device according to claim 1, wherein:
the pressurizer is integrated into the nozzle.

13. The portable oral irrigation device according to claim 1, wherein:
the nozzle and the reservoir are removably coupled to one another by a threaded neck.

14. A method for irrigating a space between two teeth, the method comprising:
placing a liquid into a liquid-holding reservoir;
moving an element coupled to the reservoir alternatively away from and toward the reservoir to activate a pressurizer and place positive pressure into an interior of the reservoir;
aiming a nozzle that is coupled to and in fluid communication with the reservoir at a space between two teeth, the nozzle having a generally arcuate shape along a length of the nozzle; and
opening a fluid pathway between the liquid in the reservoir and the nozzle outlet and projecting a single focused stream of liquid from the nozzle.

15. The method according to claim 14, wherein:
the arcuate-shaped nozzle follows a curved centerline along a length of the nozzle and is tapered toward an outlet thereof.

16. The method according to claim 14, wherein:
the fluid pathway is opened by turning a liquid emitter valve.

17. The method according to claim 14, wherein:
the pressurizer includes a movable portion that collects air therein when moved in a first direction and inserts the collected air into the reservoir when moved in a second direction.

18. The method according to claim 14, wherein:
the element is integrated into the nozzle and the nozzle is separable from the reservoir and operable to operate the pressurizer when separated from the reservoir.

19. The method according to claim 14, wherein:
the element is a bottom portion of the reservoir that is separable from an upper portion of the reservoir and operable to operate the pressurizer when separated from the upper portion of the reservoir.

20. A portable irrigation device comprising;
a liquid-holding reservoir;
an arcuate and tubular-shaped nozzle coupled to and in fluid communication with the reservoir; and
a pressurizer coupled to the reservoir, the pressurizer operable for creating a positive pressure inside the reservoir.

22. The portable oral irrigation device according to claim 1, wherein:
the nozzle has a taper that decreases in diameter in a direction toward the outlet.

23. The portable oral irrigation device according to claim 14, wherein:
the nozzle has a taper that decreases in diameter in a direction toward the outlet.
